(19) United States
(12) Patent Application Publication
(10) Pub. No.: US 2020/0045168 A1
(43) Pub. Date: Feb. 6, 2020

(54) Method and Apparatus to Identify Spam/Fraudulent/Robo Calls

(71) Applicant: Charter Communications Operating, LLC, St. Louis, CO (US)

(72) Inventor: Ashutosh Kumar SINHA, Centennial, CO (US)

(21) Appl. No.: 16/050,985

(22) Filed: Jul. 31, 2018

(51) Int. Cl. H04M 3/436; H04M 3/42; H04M 1/663; H04M 7/00

(52) U.S. Cl. CPC H04M 3/436; H04M 7/006; H04M 1/663; H04M 3/42068

(57) ABSTRACT

Systems, methods, and devices of the various embodiments disclosed herein may enable identification and management of fraudulent calls in an Internet Protocol (IP) Multimedia Subsystem (IMS) Based telecommunication network. Various embodiments may enable a user of a computing device to identify a call as unwanted and provide call type information to an IMS based telecommunication network. Various embodiments may enable a server in an IMS based telecommunication network to receive call type information from a computing device. Various embodiments may enable a server in an IMS based telecommunication network to identify a fraudulent call and update a Session Initiation Protocol (SIP) invite message to include call type information.

### BACKGROUND

In conventional Internet Protocol (IP) Multimedia Subsystem (IMS) based telecommunication networks (such as fixed line networks, Voice Over Wi-Fi (VoWifi) networks, Voice Over Long Term Evolution (LTE) (VoLTE) networks, etc.), Session Initiation Protocol (SIP) call management may provide caller information (e.g., Caller ID) to a party being called. However, such caller information may be limited to an originating phone number and/or a name. As such, SIP call management may not be able to provide information about the nature of a call.

### SUMMARY

The systems, methods, and devices of the various embodiments disclosed herein may enable management of unwanted calls by an Internet Protocol (IP) Multimedia Subsystem (IMS) based telecommunication network.

Various embodiments may include receiving call notification of a call at a server, wherein the call notification includes caller information, querying a call type database to determine whether a call type is associated with the caller information, and in response to determining that the call type is associated with the caller information, receiving the call type associated with the caller information from the call type database, modifying the call notification to include the received call type associated with the caller information, and sending the modified call notification to an intended call recipient user equipment. Some embodiments may also include, in response to determining that the call type is not associated with the caller information, forwarding the call notification to the intended call recipient user equipment.

In some embodiments, the caller information may include an originating user equipment identifier.

In some embodiments, the call type may be one of spam, fraud, survey, political, or marketing.

In some embodiments, modifying the call notification may include adding a call info header to the call notification.

In some embodiments, the call info header may include a call type field which may include a call type value.

In some embodiments, the call notification may include a Session Initiation Protocol (SIP) invite message.

Further embodiments may include receiving a call termination indication from a user equipment, which may include caller information, determining whether the call termination indication includes a call type value, and updating the call type database based on the call type value and the caller information from the call termination indication in response to determining that the call termination indication includes the call type value.

In some embodiments, determining whether the call termination indication includes a call type value may include determining, by the server, whether the call termination indication comprises a call info header, which may include a call type field including the call type value selected by a user of the user equipment.

In some embodiments, the caller information included in the call termination indication may include an originating phone number and updating the call type database based on the call type value and the caller information from the call termination indication in response to determining that the call termination indication includes the call type value may include sending, by the server, the call type value and the originating phone number to another server of the IMS based telecommunications network.

In some embodiments, the caller information included in the call termination indication may include an originating phone number and updating the call type database based on the call type value and the caller information from the call termination indication in response to determining that the call termination indication includes the call type value may include determining whether the call type database includes the originating phone number and in response to determining that the call type database does not include the originating phone number, generating a record comprising the call type value and the originating phone number, initializing a counter associated with the generated record, and storing the generated record in the call type database.

Further embodiments may include, in response to determining that the call type database does include the originating phone number, updating a record corresponding to the originating phone number to include the call type value and increasing a counter associated with the updated record.

In some embodiments, the call termination indication comprises a Session Initiation Protocol (SIP) bye message.

Various embodiments may include receiving, by the user equipment, a call notification from a server of the IMS based telecommunication network, determining whether the call notification includes a call info header comprising a call type value, in response to determining that the call notification does not include a call info header comprising a call type value, presenting caller information associated with the call notification on a graphical user interface of the user equipment, and receiving an indication via the graphical user interface to accept a call corresponding to the call notification.

In some embodiments, the call notification may include a Session Initiation Protocol (SIP) invite message.

Further embodiments may include upon establishment of a call corresponding to the call notification, presenting an option via the graphical user interface to identify the call corresponding to the call notification as an unwanted call and terminate the unwanted call and, in response to selection of the option to identify the call corresponding to the call notification as an unwanted call and terminate the unwanted call, prompting the user to identify a call type for the unwanted call, generating a call termination indication comprising a call info header, and sending the generated call termination indication from the computing device to the server. In some embodiments, the call info header may include a call type field including a call type value and the call type value may be the user identified call type for the unwanted call.

Further embodiments may include, in response to determining that the call notification does include a call info header comprising a call type value, presenting caller information associated with the call notification and the call type value via the graphical user interface of the user equipment.

In some embodiments, the call notification may include a Session Initiation Protocol (SIP) invite message and the call termination indication may include a SIP bye message.

Further embodiments disclosed herein include a computing device having a processor configured with processor-executable instructions to perform operations of the methods summarized above. Further embodiments disclosed herein include a computing device including means for performing functions of the methods summarized above. Further embodiments disclosed herein include a non-transitory processor-readable storage medium having stored thereon processor-executable instructions configured to cause a computing device processor to perform operations of the methods summarized above. Further embodiments disclosed herein include a server configured with processor executable instructions to perform operations of the methods summarized above. Further embodiments disclosed herein include a server including means for performing functions of the methods summarized above. Further embodiments disclosed herein include a non-transitory processor-readable storage medium having stored thereon processor-executable instructions configured to cause a server processor to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of various embodiments.

FIG. 1 is a communication system block diagram of an Internet Protocol (IP) network suitable for use with various embodiments.

FIG. 2 is a communication system block diagram a fixed line IP Multimedia Subsystem (IMS) based telecommunication network suitable for use with various embodiments.

FIG. 3 is a call flow diagram illustrating interactions for managing an unwanted call in an IP network.

FIG. 4A is a block diagram illustrating an HTTP message exchange for use with various embodiments.

FIG. 4B is a block diagram illustrating a call info entry in a call type database for use with various embodiments.

FIG. 4C is a block diagram illustrating an HTTP message exchange for use with various embodiments.

FIG. 5 is a call flow diagram illustrating interactions for managing an unwanted call in an IP network.

FIG. 6 is a process flow diagram illustrating an embodiment method for managing an unwanted call in an IP network.

FIG. 7 is a process flow diagram illustrating an embodiment method for managing an unwanted call in an IP network.

FIG. 8 is a process flow diagram illustrating an embodiment method for managing an unwanted call in an IP network.

FIG. 9 is a process flow diagram illustrating an embodiment method for managing an unwanted call in an IP network.

FIG. 10 is a process flow diagram illustrating an embodiment method for managing an unwanted call in an IP network.

FIG. 11 is a component diagram of an example computing device suitable for use with various embodiments.

FIG. 12 is a component diagram of an example server suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

As used herein, the term “computing device” is used to refer to any one or all of satellite or cable set top boxes, laptop computers, rack mounted computers, routers, cable modem termination systems (CMTSs), cellular telephones, smart phones, personal or mobile multi-media players, personal data assistants (PDAs), personal computers, tablet computers, smart books, palm-top computers, desk-top computers, wireless electronic mail receivers, multimedia Internet enabled cellular telephones, wireless gaming controllers, streaming media players (such as, ROKU™), smart televisions, digital video recorders (DVRs), modems, and similar electronic devices which include a programmable processor and memory and circuitry for providing the functionality described herein.

The various embodiments are described herein using the term “server” to refer to any computing device capable of functioning as a server, such as communications server, a name server, a master exchange server, web server, mail server, document server, database server, route server, content server, or any other type of server. A server may be a dedicated computing device or a computing device including a server module (e.g., running an application which may cause the computing device to operate as a server). A server module (e.g., server application) may be a full function server module, or a light or secondary server module (e.g., light or secondary server application) that is configured to provide synchronization services among the dynamic databases on computing devices. A light server or secondary server may be a slimmed-down version of server-type functionality that can be implemented on a computing device thereby enabling it to function as a server only to the extent necessary to provide the functionality described herein.

The systems, methods, and devices of the various embodiments disclosed herein may enable unwanted call management by an Internet Protocol (IP) Multimedia Subsystem (IMS) based telecommunication network. Various embodiments may enable a server in an IMS based telecommunication network, such as a proxy-call session control function (P-CSCF) server, interrogating/serving-call session control function (I/S-CSCF) server, telephony application server (TAS), etc., to manage identification and delivery of an unwanted call. Various embodiments may enable such servers in IMS based telecommunication networks (e.g., fixed line networks, Voice Over Wi-Fi (VoWifi) networks, Voice Over Long Term Evolution (LTE) (VoLTE) networks, etc.) to identify a call as potentially unwanted (e.g., fraudulent, spam, robocall, marketing, survey, etc.) and provide additional call type information with Caller ID information for the called party to make an informed decision about answering the call based on either Caller ID and the additional call type information.

In various embodiments, in response to receiving a SIP invite, a server, such as a P-CSCF server, a I/S-CSCF server, a TAS, etc., may determine whether the corresponding call is potentially unwanted. For example, the server may query a call type database to determine whether caller info associated with the caller ID exists in the call type database. In various embodiments, the call type database may be part of another server, such as a spam/fraudulent call database (S/FCDB) server. In various embodiments, the server may receive a response from the call type database. In various embodiments, the response may include a call type value if caller info associated with the caller ID exists in the call type database or a user not found indication if caller info associated with the caller ID does not exist in the call type database. In various embodiments, the server may alter the SIP invite to include a call type value returned as part of a response from the call type database. In various embodiments, the server may send the altered SIP invite to a computing device.

In various embodiments, a computing device may receive an altered SIP invite from a server, such as a P-CSCF server, a I/S-CSCF server, a TAS, etc., and present caller ID information along with a call type indication to a user of the computing device.

In various embodiments, in response to a user terminating a call as unwanted, a computing device may generate a SIP BYE message that includes a call info header. In various embodiments, the call info header may include a call type value selected by the user.

In various embodiments, in response to receiving a SIP BYE message that includes a call info header, a server, such as a P-CSCF server, a I/S-CSCF server, a TAS, etc., may update a call type database. In various embodiments, updating a call type database may include adding a new entry including a call type value from a call info header and corresponding caller info, such as an originating phone number. In various embodiments, updating a call type database may include increasing a counter of a call type entry corresponding to caller info from the SIP BYE message.

Various examples of different protocols are discussed herein, such as IMS, SIP, SDP, etc. The discussions of specific protocols, such as IMS, SIP, SDP, etc., are provided merely as examples to better illustrate the aspects of the various embodiments, and are not intended to limit the various embodiments in any way. Other protocols may be used with the various embodiments, and the other protocols may be substituted in the various examples without departing from the spirit or scope of the invention.

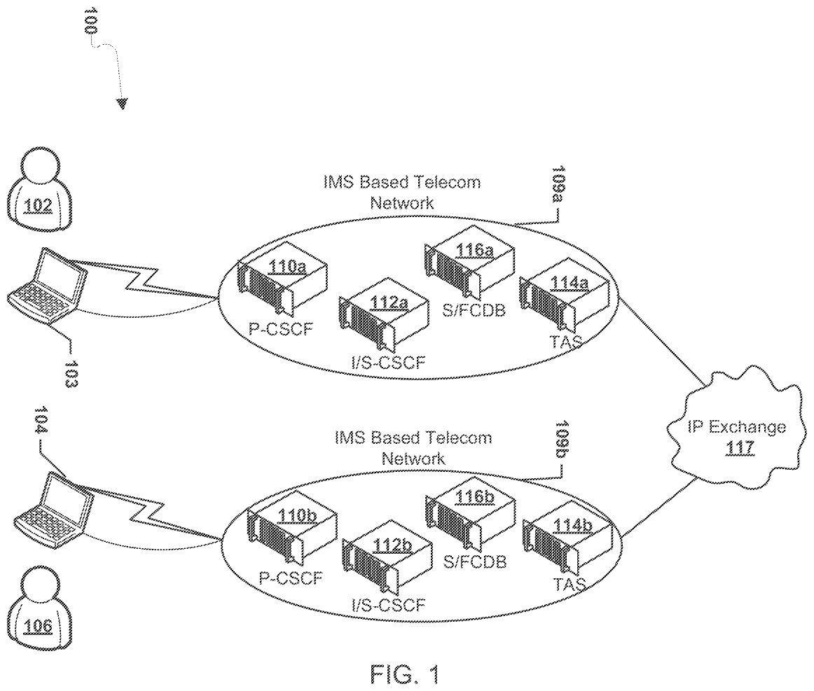

FIG. 1 illustrates an Internet Protocol (IP) communication network 100 suitable for use with various embodiments. The IP communication network 100 may include multiple devices, such as computing devices 103, 104, one or more P-CSCF servers 110a, 110b, one or more I/S-CSCF servers 112a, 112b, one or more TASs 114a, 114b, and one or more Spam/Fraudulent Call Database (S/FCDB) servers 116a, 116b. Various ones of the one or more P-CSCF servers 110a, 110b, the one or more I/S-CSCF servers 112a, 112b, the one or more TASs 114a, 114b, and the one or more S/FCDB servers 116a, 116b may be connected together in various manners to form one or more IMS based telecommunication networks 109a, 109b. The one or more P-CSCF servers 110a, 110b, the one or more I/S-CSCF servers 112a, 112b, the one or more TASs 114a, 114b, and the one or more S/FCDB servers 116a, 116b in each IMS based telecommunication network 109a, 109b may exchange data with one another via their various connections. The computing devices 103, 104 may exchange data via one or more wired or wireless connections with the one or more IMS based telecommunication networks 109a, 109b. The one or more wired or wireless connections may be established via various networking devices associated with the computing devices 103, 104, such as modems, routers, etc., enabling the computing devices 103, 104 to connect to and exchange data with the one or more IMS based telecommunication networks 109a, 109b. The one or more IMS based telecommunication networks 109a, 109b may connect to one or more IP Exchanges (IPX) 117 and may exchange data with one another via their respective connections to the one or more IPX 117. In this manner, via the connections to one another and/or the one or more IPX 117 illustrated in FIG. 1 and/or via other connections (not shown), the computing devices 103, 104, the one or more P-CSCF servers 110a, 110b, the one or more I/S-CSCF servers 112a, 112b, the one or more TASs 114a, 114b, the one or more S/FCDB servers 116a, 116b, and/or other devices of the one or more IMS based telecommunication networks 109a, 109b may exchange data with one another. For example, the computing devices 103, 104, the one or more P-CSCF servers 110a, 110b, the one or more I/S-CSCF servers 112a, 112b, the one or more TASs 114a, 114b, the one or more S/FCDB servers 116a, 116b, and/or other devices of the one or more IMS based telecommunication networks 109a, 109b may exchange data with one another via the SIP protocol.

As a specific example, computing device 103 operated by user 102 may be connected to IMS based telecommunication network 109a including one or more P-CSCF servers 110a, one or more I/S-CSCF servers 112a, one or more TASs 114a, and one or more S/FCDB servers 116a and computing device 104 operated by user 106 may be connected to IMS based telecommunication network 109b including one or more P-CSCF servers 110b, one or more I/S-CSCF servers 112b, one or more TASs 114b, and one or more S/FCDB servers 116b. Both IMS based telecommunication network 109a and IMS based telecommunication network 109b may be connected to the one or more IPX 117. User 102 may initiate a SIP call via his or her computing device 103 to user 106's computing device 104 and the SIP call may be established via connections between the computing device 103, the IMS based telecommunication network 109a (e.g., via the one or more P-CSCF servers 110a, one or more I/S-CSCF servers 112a, one or more TASs 114a, and the one or more S/FCDB servers 116a), the one or more IPX 117, the IMS based telecommunication network 109b (e.g., via the one or more P-CSCF servers 110b, one or more I/S-CSCF servers 112b, one or more TASs 114b, and one or more S/FCDB servers 116b), and the computing device 104. For example, user 102 may initiate the SIP call via a VOIP application running on the processor of his or her computing device 103.

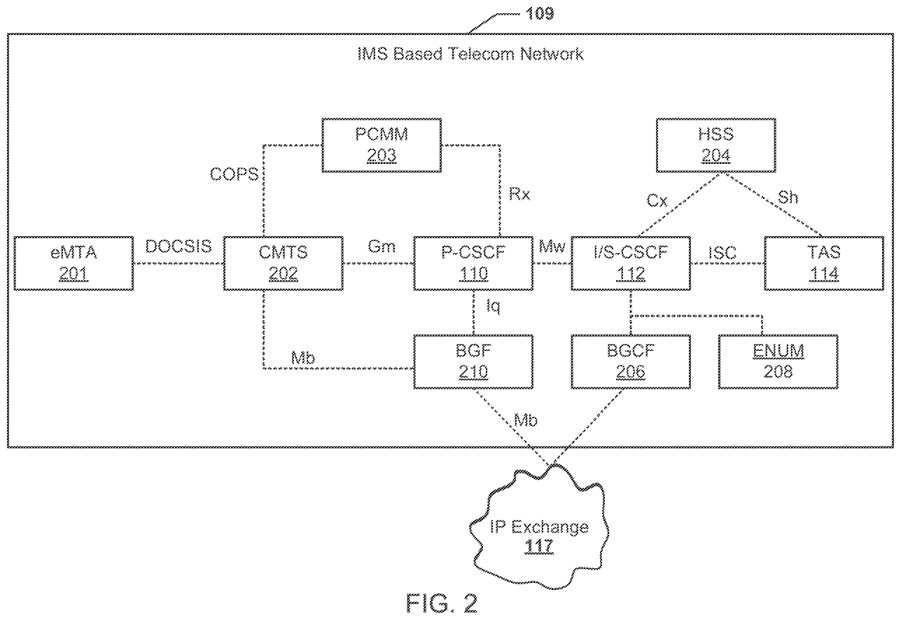

FIG. 2 illustrates an example configuration of a fixed line IMS based telecommunication network 109 suitable for use with various embodiments. With reference to FIGS. 1 and 2, the IMS based telecommunication network 109 may include an embedded multimedia terminal adapter (eMTA) 201 connected to a cable modem termination system (CMTS) 202. The eMTA 201 may be the IMS based telecommunication network 109 edge device closest to user computing devices connected to the IMS based telecommunication network 109, such as computing devices 103, 104 and may exchange data with the user computing devices, such as computing devices 103, 104, and/or the devices (e.g., modems, routers, etc.) enabling the user computing devices, such as computing devices 103, 104, to connect to the IMS based telecommunication network 109. The eMTA 201 may exchange data with the CMTS 202 according to the Data Over Cable Service Interface Specification (DOCSIS). The eMTA 201 may exchange SIP messages with the CMTS 202 and/or the user computing devices, such as computing devices 103, 104. The CMTS 202 may connect to a packet cable multimedia (PCMM) server 203, a P-CSCF 110, and a boarder gateway function (BGF) server 210. The CMTS 202 may exchange data with the PCMM server 203 via one or more connections established according to the Common Open Policy Service (COPS). The CMTS 202 may exchange data with the BGF server 210 via the media bearer (Mb) interface. The CMTS 202 may exchange data with the P-CSCF 110 via the Gm interface according to the SIP/SDP protocols. The CMTS 202 may send/receive SIP messages to/from the P-CSCF server 110. The PCMM server 203 may be connected to the P-CSCF server 110 and exchange data with the P-CSCF server 110 via the Rx interface. The P-CSCF server 110 may be connected to the BGF server 210 and exchange data with the BGF server 210 via the Iq interface. The BGF server 210 may be connected to the one or more IPX 117 via the Mb interface and may exchange data with the one or more IPX 117 via the Mb interface.

The P-CSCF server 110 may connect to the I/S-CSCF server 112 and exchange data with the I/S-CSCF server 112 via the Mw interface. The P-CSCF server 110 and I/S-CSCF server 112 may send/receive SIP messages to/from one another via the Mw interface. The I/S-CSCF server 112 may be connected to a home subscriber server (HSS) 204, a TAS 114, and a break out gateway control function (BGCF) server 206. The I/S-CSCF server 112 may exchange data with the HSS 204 via the Cx interface. The I/S-CSCF server 112 may exchange data with the TAS 114 via the ISC interface. The I/S-CSCF server 112 and TAS 114 may send/receive SIP messages to/from one another via the ISC interface. The HSS 204 may be connected to the TAS 114 and the HSS 203 and TAS 114 may exchange data via the Sh interface. The I/S-CSCF server 112 may exchange data with the BGCF server 206 which may connect to the one or more IPX 117 and may exchange data with the one or more IPX 117. The BGCF server 206 may be connected to an E.164 number to uniform resource identifier (URI) (ENUM) server 208. The TAS 114 may control the sending/receiving of SIP messages via the one or more IPX 117 to/from other IMS based telecommunication networks 109.

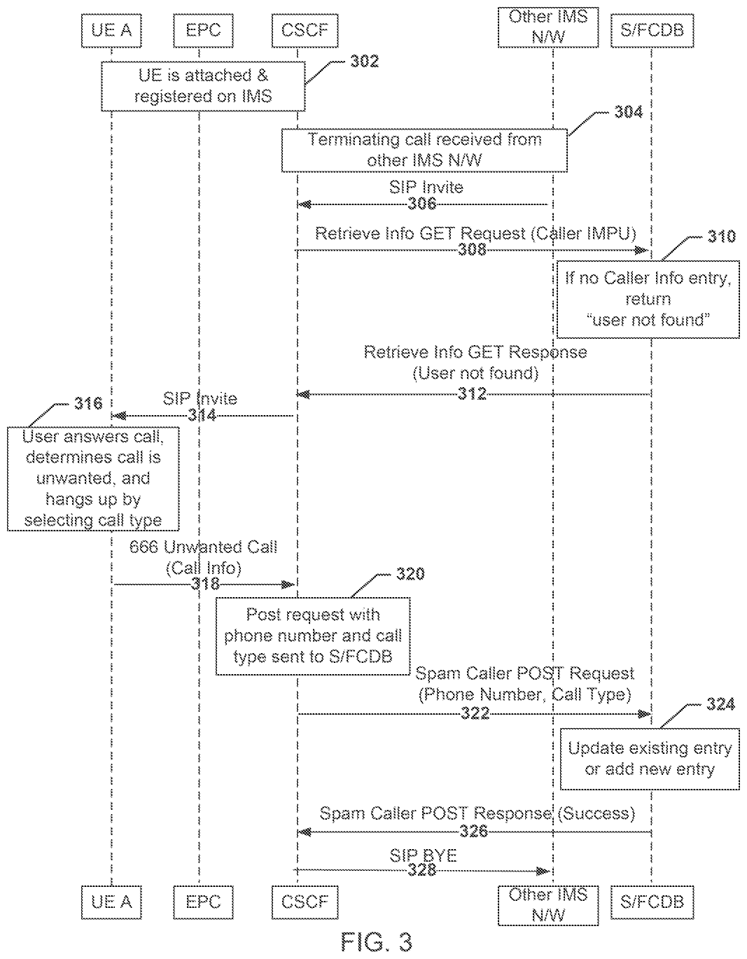

FIG. 3 is a call flow diagram illustrating interactions for managing a potentially unwanted call in an IP network. The example SIP call setup illustrated in FIG. 3 may be to attempt a call from computing device 103 as the originating computing device (i.e., the dialing device) to computing device 104 as the terminating computing device (i.e., the called device). With reference to FIGS. 1-3, a terminating computing device 104 may attach and register with the IMS based telecommunication network 109b in operation 302. In another IMS network (“Other IMS N/W”, i.e., IMS based telecommunication network 109a in FIG. 2), an originating computing device 103 may dial a call, such as in response to a user 102 interaction with the computing device 103 (e.g., a user 102 placing a VOIP call through a VOIP application running on a processor of the computing device 103), in operation 304. In some embodiments, the computing device 103 (originating device) may be operating in the same IMS based communication network 109a. The computing device 103 may generate and send a SIP invite message which is delivered to the P-CSCF 110b in the IMS based telecommunication network 109b in operation 306. The P-CSCF 110b may query the S/FCDB 116b by sending a retrieve info HTTP GET request with the IP Multimedia Public Identity (IPMU) of computing device 103 in operation 308.

The S/FCDB 116b may determine whether a call type database contains an entry corresponding to the IPMU of computing device 103 in operation 310. If the call type database does not contain an entry corresponding to the IMPU of computing device 103, the S/FCDB 116b may send a retrieve info HTTP GET response indicating “user not found” in operation 312. The P-CSCF 110b may then forward the SIP invite message to the terminating computing device 104 in operation 314.

A user 106 may interact with terminating computing device 104 to answer the call and, after identifying the call as unwanted, to terminate the call while indicating a call type in operation 316. The terminating computing device 104 may send an unwanted call notice to the P-CSCF 110b by generating a SIP BYE message that includes the indicated call type in a call info header in operation 318. The P-CSCF 110b may determine the caller IMPU and the indicated call type in operation 310. The P-CSCF 110b may provide the caller IMPU and the indicated call type to the S/FCDB 116b via a spam caller HTTP POST request in operation 322.

The S/FCDB 116b may create a new entry with the caller IMPU and the indicated call type or update an existing entry corresponding to the caller IMPU with the indicated call type in operation 324. The S/FCDB 116b may indicate successful entry creation or updating via a spam caller HTTP POST response to the P-CSCF 110b in operation 326. The P-CSCF may then forward the SIP BYE message to the originating computing device 103 in operation 328.

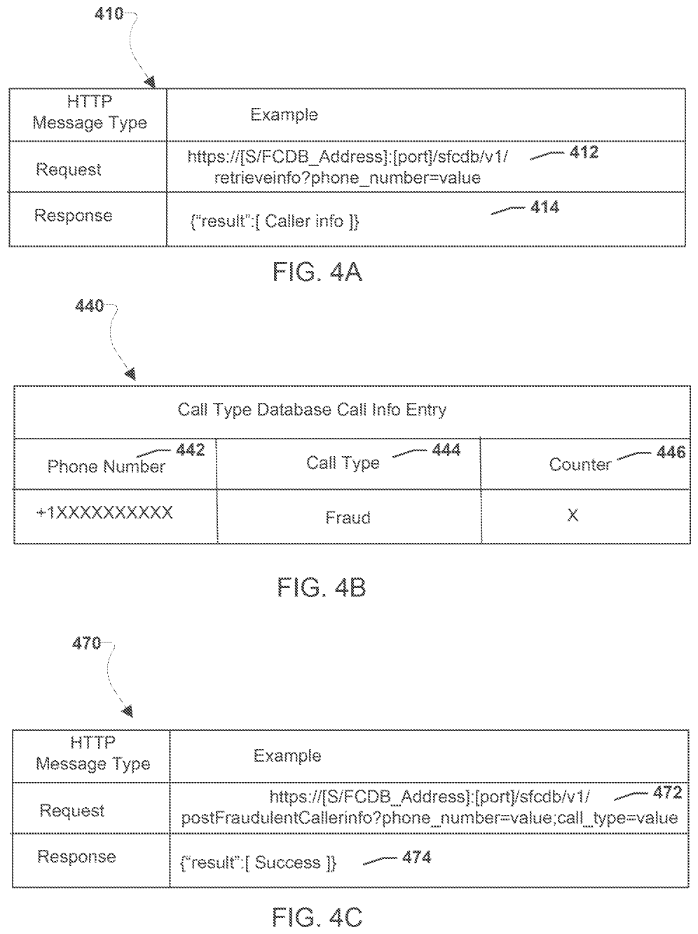

FIG. 4A is a block diagram illustrating an HTTP message exchange 410 for use in various embodiments. In various embodiments, the HTTP message exchange 410 may be performed between two servers within an IMS based telecommunication network 109, such as a P-CSCF server 110 and a S/FCDB server 116. With reference to FIGS. 1-4A, a P-CSCF server 110 may send an HTTP GET request 412 to a S/FCDB server 116, such as in operation 308 of FIG. 3. The S/FCDB server 116 may send an HTTP GET response 414 to the P-CSCF server 110, such as in operation 312 of FIG. 3.

FIG. 4B is a block diagram illustrating a call type database call info entry 440 for use in various embodiments. In various embodiments, the call type database call info entry 440 may include a phone number field 442, a call type field 444, and a counter field 446. The phone number field 442 may include a phone number, such as an originating phone number. The call type field 444 may include an indication of a call type, such as fraudulent, spam, robocall, survey, telemarketing, etc. The counter field 446 may include a count indicating a number of time the originating phone number has been identified as corresponding to a particular call type.

FIG. 4C is a block diagram illustrating an HTTP message exchange 470 for use in various embodiments. In various embodiments, the HTTP message exchange 470 may be performed between two servers within an IMS based telecommunication network 109, such as a P-CSCF server 110 and a S/FCDB server 116. With reference to FIGS. 1-4C, a P-CSCF server 110 may sent an HTTP POST request 472 to a S/FCDB server 116, such as in operation 322 of FIG. 3. The S/FCDB server 116 may send an HTTP POST response 474 to the P-CSCF server 110, such as in operation 326 of FIG. 3.

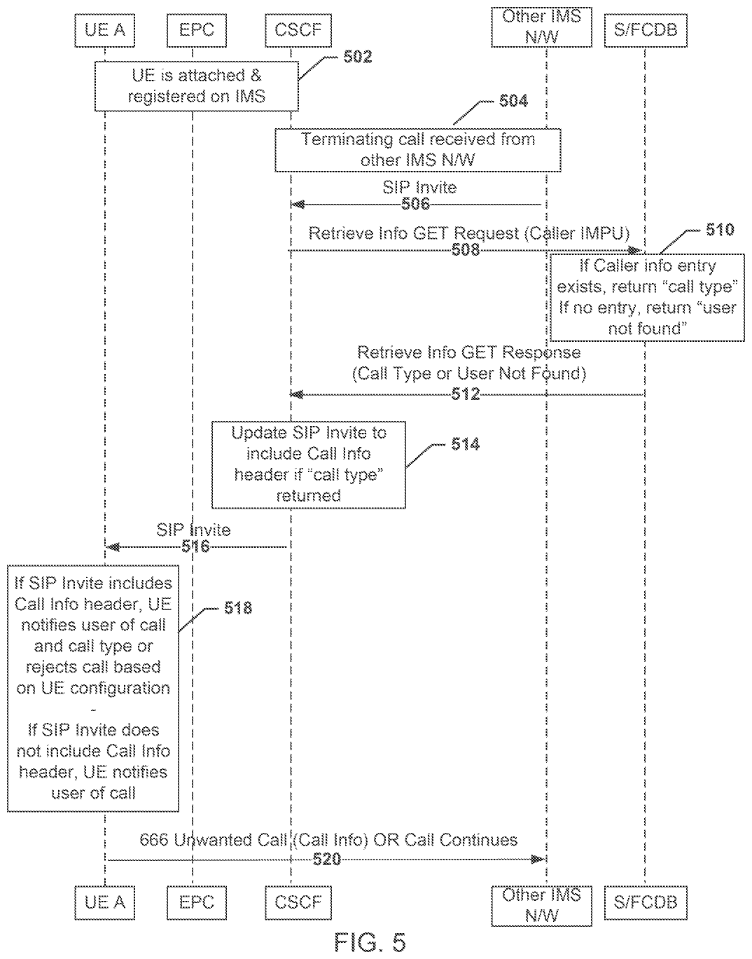

FIG. 5 is a call flow diagram illustrating interactions for managing a potentially unwanted call in an IP network. The example SIP call setup illustrated in FIG. 5 may be to attempt a call from computing device 103, operating in another IMS based communication network 109a (“Other IMS N/W”), as the originating computing device (i.e., the dialing device) to computing device 104 as the terminating computing device (i.e., the called device) operating within IMS based communication network 109b. In some embodiments, the computing device 103 (originating device) may be operating in the same IMS based communication network 109a. With reference to FIGS. 1-5, a terminating computing device 104 may attach and register with the IMS based telecommunication network 109b in operation 502. An originating computing device 103 may dial a call, such as in response to a user 102 interaction with the computing device 103 (e.g., a user 102 placing a VOIP call through a VOIP application running on a processor of the computing device 103), in operation 504. The computing device 103 may generate and send a SIP invite message which is delivered to the P-CSCF 110b in the IMS based telecommunication network 109b in operation 506. The P-CSCF 110b may query the S/FCDB 116b by sending a retrieve info HTTP GET request with the IP Multimedia Public Identity (IPMU) of computing device 103 in operation 508.

The S/FCDB 116b may determine whether a call type database contains an entry corresponding to the IPMU of computing device 103 in operation 510. The S/FCDB 116b may send a retrieve info HTTP GET response indicating “user not found” if the call type database does not contain an entry corresponding to the IMPU of computing device 103 or a retrieve info HTTP GET response including a “call type value” if the call type database does contain an entry corresponding to the IMPU of computing device 103 in operation 512.

If the retrieve info HTTP GET response includes a “call type value”, the P-CSCF 110b may alter the SIP invite message to include a call info header including the call type value in operation 514. The P-CSCF 110b may then forward the SIP invite message to the terminating computing device 104 in operation 516.

The terminating computing device 104 may notify a user 106 of the SIP invite message by presenting caller information, including a call type value if a call info header is included in the SIP invite message, in operation 518. A user 106 may interact with terminating computing device 104 to answer the call or decline the call and, if the call is declined, the terminating computing device 104 may send an unwanted call notice to the P-CSCF 110b by generating a SIP BYE message that includes the indicated call type in a call info header in operation 520.

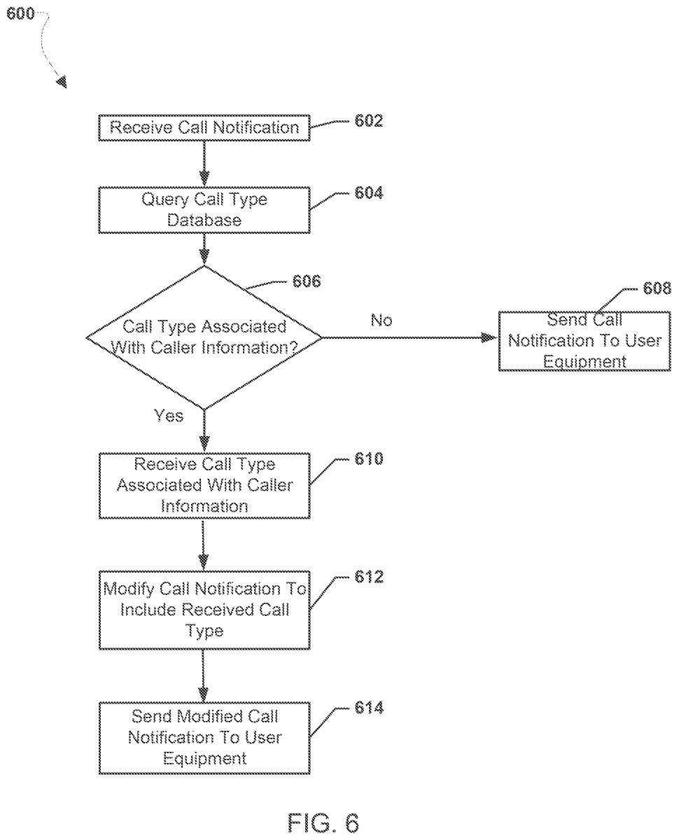

FIG. 6 is a process flow diagram illustrating an embodiment method 600 for managing a potentially unwanted call. In various embodiments, the operations of method 600 may be performed by a processor of a server in an IMS based telecommunication network 109, such as a P-CSCF server 110, a I/S-CSCF server 112, and/or a TAS 114.

With reference to FIGS. 1-6, in block 602 the server may receive a call notification. In some embodiments, the call notification may be a SIP invite message. In some embodiments, the SIP invite may be received from another computing device in the IMS based telecommunication network 109. For example, the SIP invite message may have been generated in response to a user 102 placing a VOIP call through a VOIP application running on a processor of the computing device 103.

In block 604, the server may query a call type database to determine whether a call type is associated with caller information. For example, the server may send a query that includes caller information, such as an originating phone number, contained in the call notification to the call type database and the call type database may respond with a call type value if the caller information is associated with a call type in the call type database. In some embodiments, the call type database may include one or more entries, such as the call info entry 440 of FIG. 4B. For example, the call type database may include an entry that includes a phone number, a call type value, and a counter. In various embodiments, if an entry corresponding to an originating phone number exists in a call type database, a call associated with the originating phone number may be determined to be a potentially unwanted call based on the call type value in the corresponding entry. In some embodiments, the call type database may be part of the server. In other embodiments, the call type database may be part of another server in the IMS based telecommunication network 109, such as a S/FCDB server 116. In various embodiments, the server may query a call type database by exchanging messages with another server. For example, a P-CSCF server 110 may send a query message to a S/FCDB server 116 and the S/FCDB server 116 may send a query response message to the P-CSCF server 110.

In determination block 606, the server may determine whether a call type is associated with caller information contained in the call notification. For example, if an originating phone number corresponding to a call exists in the call type database, a query response may include a corresponding call type value. Thus, if a call type value is included in a query response, the corresponding call may be identified as a call of that particular type and as a potentially unwanted call. However, if a call type value is not included in a query response, the corresponding call may be identified as not potentially unwanted. In response to determining that a call type is not associated with caller information (i.e., determination block 606=“No”), the server may send the call notification to a user equipment, such as computing device 104, in block 608. For example, the server may for the SIP invite message to computing device 104. In this manner, the call notification may be delivered without indicating that the corresponding call may be potentially unwanted.

In response to determining that a call type is associated with caller information (i.e., determination block 606=“Yes”), the server may receive the call type associated with the caller information in block 610. For example, if a call type value is included in a query response from the call type database, the server may receive the call type value from the query response.

In block 612, the server may modify the call notification to include the received call type. For example, the server may create a call info header that includes the received call type value. In some embodiments, the call info header is an additional header to be added into a SIP invite message. In this way, the SIP invite message is modified to include additional information that may indicate a call type value of the corresponding call. In some embodiments, the call type value may be one of spam, fraudulent, telemarketing, survey, robocall, political, and/or some other indicator of a call type.

In block 614, the server may send the modified call notification to a user equipment, such as computing device 104. For example, the server may send the SIP invite that includes the call info header to computing device 104. In this way, the modified call notification may be delivered with an indication that the corresponding call may be of a call type that is potentially unwanted.

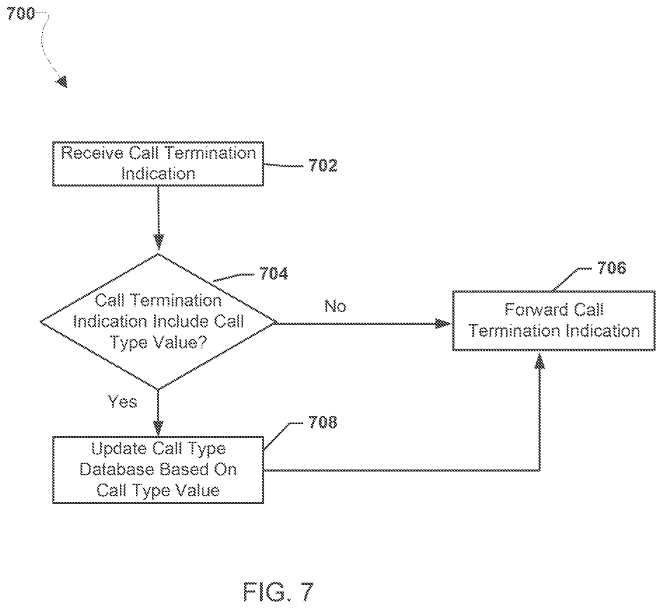

FIG. 7 is a process flow diagram illustrating an embodiment method 700 for managing a potentially unwanted call. In various embodiments, the operations of method 700 may be performed by a processor of a server in an IMS based telecommunication network 109, such as a P-CSCF server 110, a I/S-CSCF server 112, and/or a TAS 114.

With reference to FIGS. 1-7, in block 702 the server may receive a call termination indication. In some embodiments, the call termination indication may be a SIP BYE message. In some embodiments, the SIP BYE message may be received from another computing device in the IMS based telecommunication network 109. For example, the SIP BYE message may have been generated in response to a user 106 terminating a VOIP call through a VOIP application running on a processor of the computing device 104.

In determination block 704, the server may determine whether the call termination indication includes a call type value. For example, the server may determine whether the SIP BYE message includes a call info header. In various embodiments, a user may have terminated a corresponding call with an indication that the call was unwanted and the SIP BYE message may include a call info header including a call type value. For example, a user 106, after answering a call, may have determined that the call was spam, fraudulent, or otherwise unwanted and terminated the call while providing an indication of the call type. In this example, user equipment, such as computing device 104, may have created a SIP BYE message to include a call info header that includes the call type indicated by the user. In response to determining that the call termination indication does not include a call type value (i.e., determination block 704=“No”), the server may forward the call termination indication in block 706. In this way, a corresponding call may be terminated without an indication that the call is unwanted.

In response to determining that the call termination indication does include a call type value (i.e., determination block 704=“Yes”), the server may update a call type database based on the call type value in block 708. For example, the server may provide an originating phone number associated with the call and a call type value included in the call info header to the call type database. In some embodiments, the call type database may be part of the server. In some embodiments, the call type database may be part of another server in the IMS based telecommunication network 109, such as a S/FCDB server 116. In various embodiments, the server may update a call type database by a message to another server. For example, a P-CSCF server 110 may send a message including a call type value and a corresponding originating phone number to a S/FCDB server 116. The server may then forward the call termination indication in block 706. In this way, a corresponding call may be terminated with an indication that the call is unwanted.

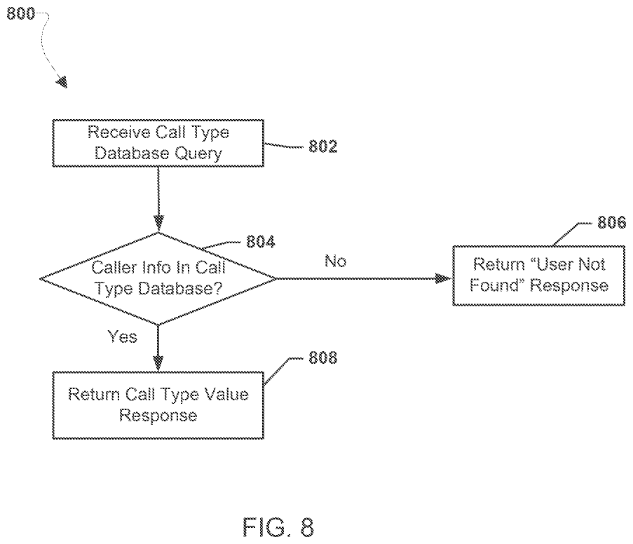

FIG. 8 is a process flow diagram illustrating an embodiment method 800 for identifying a potentially unwanted call. In various embodiments, the operations of method 800 may be performed by a processor of a server in an IMS based telecommunication network 109, such as a P-CSCF server 110 and/or a S/FCDB server 116.

With reference to FIGS. 1-8, in block 802 the server may receive a call type database query. In various embodiments, the call type database query may include caller info, such as an originating phone number, associated with a call. In various embodiments, the call type database query may be received from another server. For example, a S/FCDB server 116 may receive a call type database query from a P-CSCF server 110.

In determination block 804, the server may determine whether caller info exists in a call type database. In various embodiments, a call type database may include one or more call info entries, such as call info entry 440 of FIG. 4B. Thus, the server may determine whether caller info exists in a call type database by determining whether caller info corresponds to a call info entry within the call type database. In response to determining that caller info does not exist in a call type database (i.e., determination block 804=“No”), the server may return a “user not found” response in block 806. For example, a S/FCDB server 116 may send a message to a P-CSCF server 110 indicating that the caller info was not found in a call type database. In this way, a call may be identified as not previously indicated as unwanted.

In response to determining that call info does exist in a call type database (i.e., determination block 804=“Yes”), the server may return a call type value response in block 808. For example, a S/FCDB server 116 may send a message to a P-CSCF server 110 that includes a call type value corresponding to the caller info. In various embodiments, the call type value may be one of spam, fraudulent, robocall, political, survey, telemarketing, and/or some other value indicating a call type. In this way, a call may be identified as having a particular call type and being potentially unwanted.

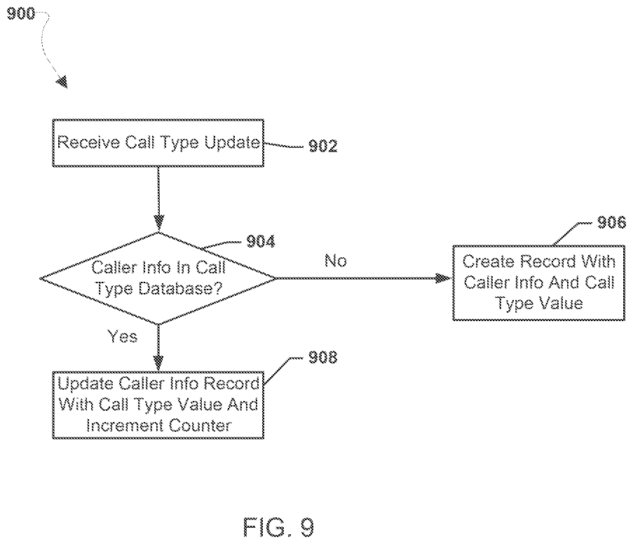

FIG. 9 is a process flow diagram illustrating an embodiment method 900 for identifying a potentially unwanted call. In various embodiments, the operations of method 900 may be performed by a processor of a server in an IMS based telecommunication network 109, such as a P-CSCF server 110 and/or a S/FCDB server 116.

With reference to FIGS. 1-9, in block 902 the server may receive a call type update. In various embodiments, the call type update may include a call type value and caller info, such as an originating phone number, associated with a call. In various embodiments, the call type update may be received from another server. For example, a S/FCDB server 116 may receive a call type update from a P-CSCF server 110.

In determination block 904, the server may determine whether caller info exists in a call type database. In various embodiments, a call type database may include one or more call info entries, such as call info entry 440 of FIG. 4B. Thus, the server may determine whether caller info exists in a call type database by determining whether caller info corresponds to a call info entry within the call type database. In response to determining that caller info does not exist in a call type database (i.e., determination block 904=“No”), the server may create an entry in the call type database corresponding to the call type value and the caller info received as part of the call type update in block 906. In this way, a call type database may be updated to include an indication that subsequent calls corresponding to the caller info may be identified as potentially unwanted.

In response to determining that caller info does exist in a call type database (i.e., determination block 804=“Yes”), the server may update an existing entry in the call type database in block 908. For example, the server may update an existing entry by updating a call type value included in the entry and/or incrementing a counter included in the entry. In this way, a call type database may be updated to include the most recent indication of a call type associated with a call as well as a total number of times a call corresponding to the caller info has been identified as unwanted.

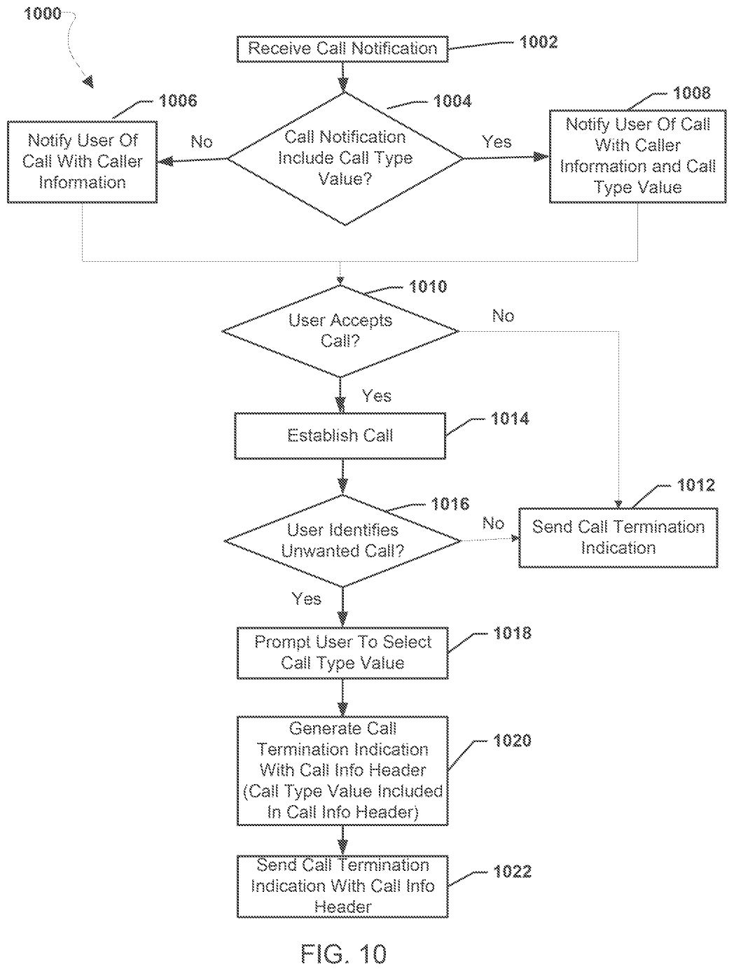

FIG. 10 is a process flow diagram illustrating an embodiment method 1000 for identifying and managing a potentially unwanted call. In various embodiments, the operations of method 1000 may be performed by a processor of a user equipment or computing device in an IMS based telecommunication network 109, such as a computing device 104.

With reference to FIGS. 1-10, in block 1002 the computing device may receive a call notification. In some embodiments, the call notification may be a SIP invite message. In some embodiments, the SIP invite may be received from a server in the IMS based telecommunication network 109. For example, the SIP invite message may have been generated in response to a user 102 placing a VOIP call through a VOIP application running on a processor of the computing device 103 and forwarded for delivery by a P-CSCF server 110.

In determination block 1004, the computing device may determine whether the call notification includes a call type value. For example, the computing device may determine whether the received call notification includes a call info header. In some embodiments, the call info header is an additional header that may include a call type field containing a call type value.

In response to determining that the call notification does not include a call type value (i.e., determination block 1004=“No”), the computing device may notify a user of the call with caller information from the call notification in block 1006. For example, a computing device 104 may notify a user 106 by presenting caller information from the SIP invite message via a graphical user interface.

In response to determining that the call notification does include a call type value (i.e., determination block 1004=“Yes”), the computing device may notify a user of the call with caller information and the call type value from the call notification in block 1008. For example, a computing device 104 may notify a user 106 by presenting the call type value included in the call info header and caller information from the SIP invite message via a graphical user interface.

In determination block 1010, the computing device may determine whether the user accepts a call corresponding to the received call notification. In various embodiments, a user may accept or decline a call by pressing a corresponding button via a graphical user interface presented by a computing device. For example, a user 106 may press a call accept button presented by a computing device 104 via a graphical user interface. In this example, the call accept button may be presented as part of or in conjunction with the call notification presented in block 1006 or block 1008. In response to determining that the user does not accept the call (i.e., determination block 1010=“No”), the computing device may send a call termination indication in block 1012. In some embodiments, the call termination indication may be a SIP BYE message. In this way, a user, being informed that a corresponding call has a particular call type, may choose not to accept the call and instead terminate the call without answering.

In response to determining that the user does accept the call (i.e., determination block 1010=“Yes”), the computing device may establish the call associated with the call notification. For example, a user 106 may have indicated acceptance of the call via a graphical user interface of a computing device 104. In various embodiments, a user 106 may have accepted the call without a knowledge of a type corresponding to the call.

In determination block 1016, the computing device may determine whether a user identifies the call as an unwanted call. For example, a call may be one of spam, fraudulent, robocall, telemarketing, survey, political, and/or some other unwanted type. In this example, a user may terminate the call prematurely. Alternatively, a user may not identify a call as unwanted and proceed to conduct the call. In response to determining that the user does not identify the call as unwanted (i.e., determination block 1016=“No”), the computing device may send a call termination indication after the user completes the call in block 1012. In some embodiments, the call termination indication may be a SIP BYE message. In this way, a user may conduct a wanted called through to completion.

In response to determining that the user identifies the call as unwanted (i.e., determination block 1016=“Yes”), the computing device may prompt a user to select a call type value in block 1018. For example, a computing device 104 may present a user 106 a selection of call type values via a graphical user interface after or as part of an indication by user 106 to terminate the call as unwanted. As a further example, the user 106 may terminate the call as unwanted by pressing a unwanted call button presented via a graphical user interface and, in response to the unwanted call button being pressed, the computing device 104 may present the user 106 with a number of different call type values via the graphical user interface. In various embodiments, the call type values may include spam, fraudulent, robocall, telemarketing, survey, political, and/or some other call type value.

In block 1020, the computing device may generate a call termination indication that includes a user selected call type value. In some embodiments, the call termination indication may be a SIP BYE message. In some embodiments, the user selected call type value may be included in a call info header. In some embodiments, the call info header may be an additional header added to a SIP BYE message. In some embodiments, the user selected call type value may be contained in a call type field included in a call info header. In this way, a computing device may alter a call termination indication to include an indication that a call is unwanted and a corresponding call type.

In block 1022, the computing device may send the call termination indication with the call info header. For example, a computing device 106 may send the SIP BYE message including the call info header to a P-CSCF server 110. In this way, a computing device may inform an IMS telecommunication network of a call type associated with an unwanted call.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 600, 700, 800, 900, and 1000 may be substituted for or combined with one or more operations of the methods 600, 700, 800, 900, and 1000, and vice versa.

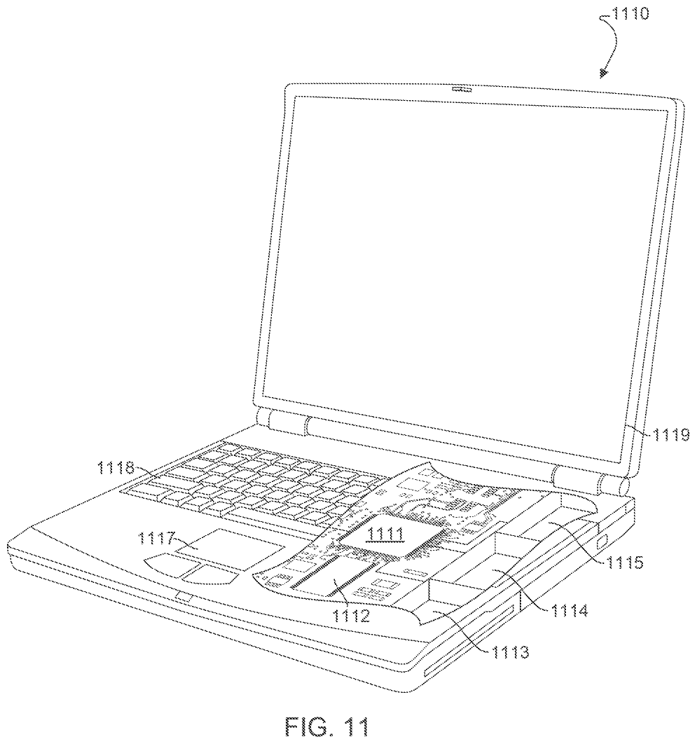

The various embodiments (including, but not limited to, embodiments discussed above with reference to FIGS. 1-10) described above may also be implemented within a variety of computing devices, such as a laptop computer 1110 as illustrated in FIG. 11. Many laptop computers include a touch pad touch surface 1117 that serves as the computer's pointing device, and thus may receive drag, scroll, and flick gestures similar to those implemented on mobile computing devices equipped with a touch screen display and described above. A laptop computer 1110 will typically include a processor 1111 coupled to volatile memory 1112 and a large capacity nonvolatile memory, such as a disk drive 1113 of Flash memory. The laptop computer 1110 may also include a floppy disc drive 1114 and a compact disc (CD) drive 1115 coupled to the processor 1111. The laptop computer 1110 may also include a number of connector ports coupled to the processor 1111 for establishing data connections or receiving external memory devices, such as a USB or FireWire® connector sockets, or other network connection circuits (e.g., interfaces) for coupling the processor 1111 to a network. In a notebook configuration, the computer housing may include the touchpad 1117, the keyboard 1118, and the display 1119 all coupled to the processor 1111. Other configurations of the computing device may include a computer mouse or trackball coupled to the processor (e.g., via a USB input) as are well known, which may also be used in conjunction with the various embodiments.

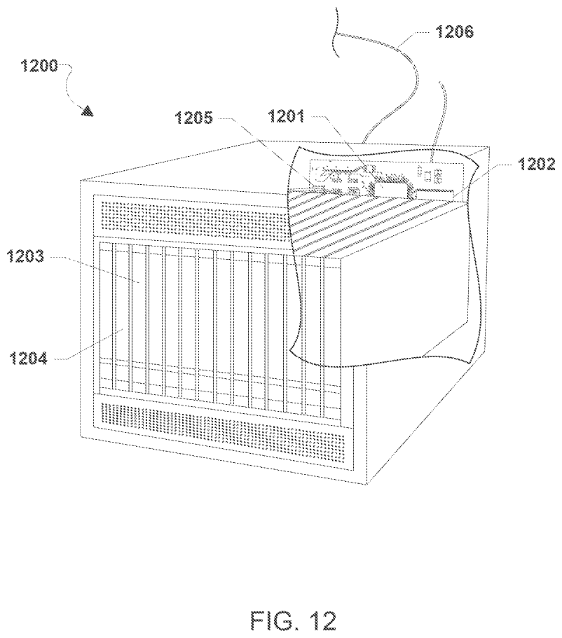

Various embodiments (including, but not limited to, embodiments discussed above with reference to FIGS. 1-10) may be implemented on any of a variety of commercially available server devices, such as the server device 1200 illustrated in FIG. 12. Such a server device 1200 may include a processor 1201 coupled to volatile memory 1202 and a large capacity nonvolatile memory, such as a disk drive 1203. The server device 1200 may also include a floppy disc drive, compact disc (CD) or DVD disc drive 1204 coupled to the processor 1201. The server device 1200 may also include network access ports 1206 coupled to the processor 1201 for establishing data connections with a network connection circuit 1205 and a communication network (e.g., IP network) coupled to other communication system network elements.

The processors 1111, 1201 may be any programmable microprocessor, microcomputer or multiple processor chip or chips that can be configured by software instructions (applications) to perform a variety of functions, including the functions of the various embodiments described above. In some devices, multiple processors may be provided, such as one processor dedicated to wireless communication functions and one processor dedicated to running other applications. Typically, software applications may be stored in the internal memory before they are accessed and loaded into the processors 1111, 1201. The processors 1111, 1201 may include internal memory sufficient to store the application software instructions. In many devices, the internal memory may be a volatile or nonvolatile memory, such as flash memory, or a mixture of both. For the purposes of this description, a general reference to memory refers to memory accessible by the processors 1111, 1201 including internal memory or removable memory plugged into the device and memory within the processors 1111, 1201 themselves. Additionally, as used herein, any reference to a memory may be a reference to a memory storage and the terms may be used interchangeable.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof. If implemented in software, the functions may be stored as one or more instructions or code on a non-transitory computer-readable medium or non-transitory processor-readable medium. The steps of a method or algorithm disclosed herein may be embodied in a processor-executable software module and/or processor-executable instructions, which may reside on a non-transitory computer-readable or non-transitory processor-readable storage medium. Non-transitory server-readable, computer-readable or processor-readable storage media may be any storage media that may be accessed by a computer or a processor. By way of example but not limitation, such non-transitory server-readable, computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, DVD, floppy disk, and Blu-ray disc where disks usually reproduce data magnetically, while discs reproduce data optically with lasers. Combinations of the above are also included within the scope of non-transitory server-readable, computer-readable and processor-readable media. Additionally, the operations of a method or algorithm may reside as one or any combination or set of codes and/or instructions on a non-transitory server-readable, processor-readable medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for identifying unwanted calls by an Internet Protocol (IP) Multimedia Subsystem (IMS) based telecommunication network, comprising:
receiving call notification of a call at a server, wherein the call notification includes caller information;
querying a call type database to determine whether a call type is associated with the caller information;
in response to determining that the call type is associated with the caller information:
receiving the call type associated with the caller information from the call type database;
modifying the call notification to include the received call type associated with the caller information; and
sending the modified call notification to an intended call recipient user equipment; and
in response to determining that the call type is not associated with the caller information:
forwarding the call notification to the intended call recipient user equipment.

2. The method of claim 1, wherein the caller information comprises an originating user equipment identifier.

3. The method of claim 1, wherein the call type is one of spam, fraud, survey, political, or marketing.

4. The method of claim 1, wherein modifying the call notification comprises adding a call info header to the call notification.

5. The method of claim 4, wherein the call info header comprises a call type field, the call type field including a call type value.

6. The method of claim 1, wherein the call notification comprises a Session Initiation Protocol (SIP) invite message.

7. The method of claim 1, further comprising:
receiving a call termination indication from a user equipment, wherein the call termination indication includes caller information;
determining whether the call termination indication includes a call type value; and
updating the call type database based on the call type value and the caller information from the call termination indication in response to determining that the call termination indication includes the call type value.

8. The method of claim 7, wherein determining whether the call termination indication includes a call type value comprises determining, by the server, whether the call termination indication comprises a call info header, the call info header comprising a call type field including the call type value selected by a user of the user equipment.

9. The method of claim 7, wherein:
the caller information included in the call termination indication comprises an originating phone number; and
updating the call type database based on the call type value and the caller information from the call termination indication in response to determining that the call termination indication includes the call type value comprises:
sending, by the server, the call type value and the originating phone number to another server of the IMS based telecommunications network.

10. The method of claim 7, wherein:
the caller information included in the call termination indication comprises an originating phone number; and
updating the call type database based on the call type value and the caller information from the call termination indication in response to determining that the call termination indication includes the call type value comprises:
determining whether the call type database includes the originating phone number; and
in response to determining that the call type database does not include the originating phone number:
generating a record comprising the call type value and the originating phone number;
initializing a counter associated with the generated record; and
storing the generated record in the call type database.

11. The method of claim 10, further comprising:
in response to determining that the call type database does include the originating phone number:
updating a record corresponding to the originating phone number to include the call type value; and
increasing a counter associated with the updated record.

12. The method of claim 7, wherein the call termination indication comprises a Session Initiation Protocol (SIP) bye message.

13. A method for identifying unwanted calls from an Internet Protocol (IP) Multimedia Subsystem (IMS) based telecommunication network by a user equipment, comprising:
receiving, by the user equipment, a call notification from a server of the IMS based telecommunication network;
determining whether the call notification includes a call info header comprising a call type value;
in response to determining that the call notification does not include a call info header comprising a call type value, presenting caller information associated with the call notification on a graphical user interface of the user equipment; and
receiving an indication via the graphical user interface to accept a call corresponding to the call notification.

14. The method of claim 13, wherein the call notification comprises a Session Initiation Protocol (SIP) invite message.

15. The method of claim 13, further comprising:
upon establishment of a call corresponding to the call notification, presenting an option via the graphical user interface to identify the call corresponding to the call notification as an unwanted call and terminate the unwanted call; and
in response to selection of the option to identify the call corresponding to the call notification as an unwanted call and terminate the unwanted call:
prompting the user to identify a call type for the unwanted call;
generating a call termination indication comprising a call info header, wherein:
the call info header comprises a call type field including a call type value; and
the call type value is the user identified call type for the unwanted call; and
sending the generated call termination indication from the computing device to the server.

16. The method of claim 13, further comprising:
in response to determining that the call notification does include a call info header comprising a call type value, presenting caller information associated with the call notification and the call type value via the graphical user interface of the user equipment.

17. The method of claim 13, wherein:
the call notification comprises a Session Initiation Protocol (SIP) invite message; and
the call termination indication comprises a SIP bye message.

18. A server, comprising:
a network interface;
a memory storage; and
a processor coupled to the network interface and the memory storage, wherein the processor is configured with processor-executable instructions to:
receive call notification of a call, wherein the call notification includes caller information;
query a call type database to determine whether a call type is associated with the caller information;
in response to determining that the call type is associated with the caller information:
receive the call type associated with the caller information from the call type database;
modify the call notification to include the received call type associated with the caller information; and
send the modified call notification to an intended call recipient user equipment; and
in response to determining that the call type is not associated with the caller information:
forward the call notification to the intended call recipient user equipment.

19. The server of claim 18, wherein the processor is further configured with processor-executable instructions to receive call notification of a call by receiving a Session Initiation Protocol (SIP) invite message.

20. The server of claim 18, wherein the processor is configured with processor-executable instructions to modify the call notification by adding a call info header to the call notification, the call info header comprising a call type field, the call type field including a call type value.

21. The server of claim 18, wherein the processor is further configured with processor-executable instructions to:
receive a call termination indication from a user equipment, wherein the call termination indication includes caller information;
determine whether the call termination indication includes a call type value; and
update the call type database based on the call type value and the caller information from the call termination indication in response to determining that the call termination indication includes the call type value.

22. The server of claim 21, wherein the processor is further configured with processor-executable instructions to determine whether the call termination indication includes a call type value by determining whether the call termination indication comprises a call info header, the call info header comprising a call type field including the call type value selected by a user of the user equipment.

23. The server of claim 21, wherein:
the caller information included in the call termination indication comprises an originating phone number; and
the processor is configured with processor-executable instructions to update the call type database based on the call type value and the caller information from the call termination indication in response to determining that the call termination indication includes the call type value by:
sending the call type value and the originating phone number to another server of an Internet Protocol (IP) Multimedia Subsystem (IMS) based telecommunications network.

24. The server of claim 21, wherein:
the caller information included in the call termination indication comprises an originating phone number; and
the processor is further configured with processor-executable instructions to update the call type database based on the call type value and the caller information from the call termination indication in response to determining that the call termination indication includes the call type value by:
determining whether the call type database includes the originating phone number; and
in response to determining that the call type database does not include the originating phone number:
generating a record comprising the call type value and the originating phone number;
initializing a counter associated with the generated record; and
storing the generated record in the call type database.

25. The server of claim 24, wherein the processor is further configured with processor-executable instructions to:
in response to determining that the call type database does include the originating phone number:
update a record corresponding to the originating phone number to include the call type value; and
increase a counter associated with the updated record.

26. The server of claim 21, wherein the processor is configured with processor-executable instructions to receive a call termination indication by receiving a Session Initiation Protocol (SIP) bye message.

27. A user equipment, comprising:
a network interface;
a memory storage; and
a processor coupled to the network interface and the memory storage, wherein the processor is configured with processor-executable instructions to:
receive a call notification from a server of an Internet Protocol (IP) Multimedia Subsystem (IMS) based telecommunication network;
determine whether the call notification includes a call info header comprising a call type value;
in response to determining that the call notification does not include a call info header comprising a call type value, present caller information associated with the call notification on a graphical user interface of the user equipment; and
receive an indication via the graphical user interface to accept a call corresponding to the call notification.

28. The user equipment of claim 27, wherein the processor is further configured with processor-executable instructions to:
upon establishment of a call corresponding to the call notification, present an option via the graphical user interface to identify the call corresponding to the call notification as an unwanted call and terminate the unwanted call; and
in response to selection of the option to identify the call corresponding to the call notification as an unwanted call and terminate the unwanted call:
prompt the user to identify a call type for the unwanted call;
generate a call termination indication comprising a call info header, wherein:
the call info header comprises a call type field including a call type value; and
the call type value is the user identified call type for the unwanted call; and
send the generated call termination indication from the computing device to the server.

29. The user equipment of claim 28, wherein the processor is further configured with processor-executable instructions to:
receive the call notification by receiving a Session Initiation Protocol (SIP) invite message; and
send the call termination indication by sending a SIP bye message.

30. The user equipment of claim 27, wherein the processor is further configured with processor-executable instructions to:
in response to determining that the call notification does include a call info header comprising a call type value, present caller information associated with the call notification and the call type value via the graphical user interface of the user equipment.
